(19) United States
(12) Patent Application Publication
(10) Pub. No.: US 2025/0175933 A1
(43) Pub. Date: May 29, 2025

(54) ELECTRONIC DEVICE AND METHOD FOR USE IN WIRELESS COMMUNICATION AND COMPUTER READABLE STORAGE MEDIUM

(71) Applicant: Sony Group Corporation, Tokyo (JP)

(72) Inventors: Jinhui CHEN, Beijing (CN); Haojin LI, Beijing (CN)

(73) Assignee: Sony Group Corporation, Tokyo (JP)

(21) Appl. No.: 18/843,348

(22) PCT Filed: Mar. 7, 2023
(86) PCT No.: PCT/CN2023/080084

§ 371 Date: Sep. 3, 2024

(30) Foreign Application Priority Data
Mar. 14, 2022 (CN) 202210248152.8

(51) Int. Cl. H04W 64/00; H04L 5/00; H04W 72/25; H04W 92/18

(52) U.S. Cl. CPC H04W 64/00; H04L 5/0051; H04W 72/25; H04W 92/18

(57) ABSTRACT

The present disclosure provides an electronic device and method for use in wireless communication and a computer readable storage medium. The electronic device comprises: a processing circuit configured to generate a first signal, the first signal being used for indicating whether a first communication device is within the coverage range of a base station and/or whether the first communication device has performed network side positioning; and send the first signal to one or more second communication devices, wherein the first signal is used by the second communication devices for positioning calculation.

The present application claims the priority to Chinese Patent Application No. 202210248152.8, titled “ELECTRONIC DEVICE AND METHOD FOR USE IN WIRELESS COMMUNICATION AND COMPUTER READABLE STORAGE MEDIUM”, filed on Mar. 14, 2022 with the China National Intellectual Property Administration, which is incorporated herein by reference in its entirety.

### FIELD

The present disclosure generally relates to the field of wireless communications, and in particular to communication device positioning technology in wireless communications. More specifically, the present disclosure relates to an electronic apparatus and a method for wireless communications and a computer-readable storage medium.

### BACKGROUND

Communication device positioning technology supports or assists in the calculation of geographical positions of communication devices. The obtained position information may be used, for example, to support a wireless resource management function and position-based services of operators.

In sidelink communications, for example, two parties of the communication such as user equipments (UE) may exchange information through, for example, a PC5 interface. Moreover, there may be three coverage scenarios: a full coverage scenario, a partial coverage scenario and an out-of-coverage scenario. In the full coverage scenario, both UE are within a coverage range of a base station. In the partial coverage scenario, one UE is within the coverage range of the base station while the other UE is not within the coverage range of the base station. In the out-of-coverage scenario, neither UE is within the coverage range of the base station.

### SUMMARY

In the following, an overview of the present disclosure is given simply to provide basic understanding to some aspects of the present disclosure. It should be understood that this overview is not an exhaustive overview of the present disclosure. It is not intended to determine a critical part or an important part of the present disclosure, nor to limit the scope of the present disclosure. An object of the overview is only to give some concepts in a simplified manner, which serves as a preface of a more detailed description described later.

According to an aspect of the present disclosure, an electronic apparatus for wireless communications is provided. The electronic apparatus includes processing circuitry. The processing circuitry is configured to: generate a first signal, which is used to indicate whether a first communication device is within a coverage range of a base station and/or whether the first communication device has performed network side positioning; and transmit the first signal to one or more second communication devices, where, the first signal is used by the second communication device for positioning calculation.

According to another aspect of the present disclosure, a method for wireless communications is provided. The method includes: generating a first signal, which is used to indicate whether a first communication device is within a coverage range of a base station and/or whether the first communication device has performed network side positioning; and transmitting the first signal to one or more second communication devices, where the first signal is used by the second communication device for positioning calculation.

According to an aspect of the present disclosure, an electronic apparatus for wireless communications is provided. The electronic apparatus includes processing circuitry. The processing circuitry is configured to: receive, from a first communication device, a first signal which is used to indicate whether the first communication device is within a coverage range of a base station and/or whether the first communication device has performed network side positioning, and perform positioning calculation of a second communication device using the first signal.

According to another aspect of the present disclosure, a method for wireless communications is provided. The method includes: receiving, from a first communication device, a first signal which is used to indicate whether the first communication device is within a coverage range of a base station and/or whether the first communication device has performed network side positioning, and performing positioning calculation of the second communication device using the first signal.

According to other aspects of the present disclosure, there are further provided computer program codes and computer program products for implementing the methods for wireless communications above, and a computer-readable storage medium having recorded thereon the computer program codes for implementing the methods for wireless communications described above.

With the electronic apparatus and the method according to the embodiments of the present disclosure, the first signal is used to indicate to another communication device whether a present communication device is within the coverage range of the base station and/or whether the present communication device has performed network side positioning, so that another communication device can perform positioning calculation based on the first signal, thereby improving accuracy, efficiency and flexibility of the positioning.

These and other advantages of the present disclosure will be more apparent from the following detailed description of preferred embodiments of the present disclosure in conjunction with the accompanying drawings.

### BRIEF DESCRIPTION OF THE DRAWINGS

To further set forth the above and other advantages and features of the present disclosure, detailed description will be made in the following taken in conjunction with accompanying drawings in which identical or like reference signs designate identical or like components. The accompanying drawings, together with the detailed description below, are incorporated into and form a part of the specification. It should be noted that the accompanying drawings only illustrate, by way of example, typical embodiments of the present disclosure and should not be construed as a limitation to the scope of the disclosure. In the accompanying drawings:

FIG. 1 shows a block diagram of functional modules of an electronic apparatus for wireless communications according to an embodiment of the present disclosure;

FIG. 2 shows a schematic diagram of a relevant information flow between communication devices;

FIG. 3A shows an example of a new sidelink control indicator format;

FIG. 3B shows an example of a subframe including first positioning information;

FIG. 4 shows a schematic diagram of a relevant information flow between communication devices;

FIG. 5 shows a schematic diagram of a relevant information flow between communication devices;

FIG. 6 shows a schematic diagram of a relevant information flow between communication devices;

FIG. 7 is a block diagram showing functional modules of an electronic apparatus for wireless communications according to another embodiment of the present disclosure;

FIG. 8 is a schematic diagram showing an example of positioning calculation of a second communication device and a relevant information flow;

FIG. 9 is a schematic diagram showing another example of positioning calculation of a second communication device and a relevant information flow;

FIG. 10 is a schematic diagram showing another example of positioning calculation of a second communication device and a relevant information flow;

FIG. 11 is a schematic diagram showing another example of positioning calculation of a second communication device and a relevant information flow;

FIG. 12 is a flow chart showing a method for wireless communications according to an embodiment of the present disclosure;

FIG. 13 is a flow chart showing a method for wireless communications according to another embodiment of the present disclosure;

FIG. 14 is a block diagram showing an example of an exemplary configuration of a smartphone to which the technology of the present disclosure may be applied;

FIG. 15 is a block diagram showing an example of an exemplary configuration of a car navigation apparatus to which the technology of the present disclosure can be applied; and

FIG. 16 is a block diagram of an exemplary block diagram illustrating the structure of a general purpose personal computer capable of realizing the method and/or device and/or system according to the embodiments of the present disclosure.

### DETAILED DESCRIPTION

An exemplary embodiment of the present disclosure will be described hereinafter in conjunction with the accompanying drawings. For the purpose of conciseness and clarity, not all features of an embodiment are described in this specification. However, it should be understood that multiple decisions specific to the embodiment have to be made in a process of developing any such embodiment to realize a particular object of a developer, for example, conforming to those constraints related to a system and a service, and these constraints may change as the embodiments differs. Furthermore, it should also be understood that although the development work may be very complicated and time-consuming, for those skilled in the art benefiting from the present disclosure, such development work is only a routine task.

Here, it should also be noted that in order to avoid obscuring the present disclosure due to unnecessary details, only a device structure and/or processing steps closely related to the solution according to the present disclosure are illustrated in the accompanying drawing, and other details having little relationship to the present disclosure are omitted.

### First Embodiment

FIG. 1 shows a block diagram of functional modules of an electronic apparatus 100 according to an embodiment of the present disclosure. As shown in FIG. 1, the electronic apparatus 100 includes a generation unit 101 and a communication unit 102. The generation unit 101 is configured to generate a first signal which is used to indicate whether a first communication device is within a coverage range of a base station and/or whether the first communication device has performed network side positioning. The communication unit 102 is configured to transmit the first signal to one or more second communication devices for positioning calculation.

The generation unit 101 and the communication unit 102 may be implemented by one or more processing circuitries, and the processing circuitry, for example, may be implemented as a chip or a processor. Moreover, it should be understood that various functional units in the electronic apparatus shown in FIG. 1 are only logical modules divided based on the specific functions thereof, and are not intended to limit a specific implementation.

The electronic apparatus 100 may be, for example, provided on a first communication device side or communicatively connected to the first communication device. The first communication device and the second communication device may be UE, for example. Exemplarily, in a vehicle-to-everything (V2X) communication scenario, the first communication device and the second communication device may be user equipment in V2X, and may be provided on a vehicle side, for example.

Here, it should also be noted that the electronic apparatus 100 may be implemented in a chip level or a device level. For example, the electronic apparatus 100 may operate as a communication device (such as UE) itself, and may further include an external device such as a memory, or a transceiver (not shown in FIG. 1). The memory may be used to store programs and related data information for the communication device to implement various functions. The transceiver may include one or more communication interfaces to support communication with different devices (for example, another communication device, a base station or the like), and the implementation of the transceiver is not limited herein.

In addition, the first, the second, and the like in the present disclosure are only used for distinction, and do not imply any meaning of order or other aspects.

For sidelink communication, as two parties of the communication, communication devices may be in different base station coverage scenarios. In different base station coverage scenarios, the communication devices may obtain different information related to positioning, and thus calculation schemes for sidelink positioning are different. For example, when a communication device is within the coverage range of the base station, the communication device may perform network side positioning, for example, through communication with the base station and measurement to obtain geographical position information of the communication device. The geographical position information obtained in this way may serve as, for example, a reference for a geographical position of the other party's communication device in the sidelink communication. Therefore, acquisition of a base station coverage state of the other party's communication device (that is, whether the other party's communication device is within the coverage range of the base station) and/or whether the other party's communication device has performed network side positioning is very meaningful for determining an appropriate positioning calculation scheme and performing efficient positioning.

In this embodiment, a solution is proposed in which the first communication device indicates, through the first signal to the second communication device, the base station coverage state of the first communication device and/or whether the first communication device has performed network side positioning. In a case of the first signal indicating that the first communication device is within the coverage range of the base station and/or the first communication device has performed network side positioning, the communication unit 102 is further configured to transmit first positioning information acquired by the first communication device based on the network side positioning in a subframe associated with the first signal. The first positioning information is, for example, an absolute position of the first communication device. Specifically, the first positioning information is, for example, latitude and longitude coordinates of the first communication device. In another example, the first positioning information is a relative position of the first communication device. Specifically, the first positioning information is, for example, a relative position of the first communication device with respect to a reference point. For example, a position of the base station may serve as the reference point.

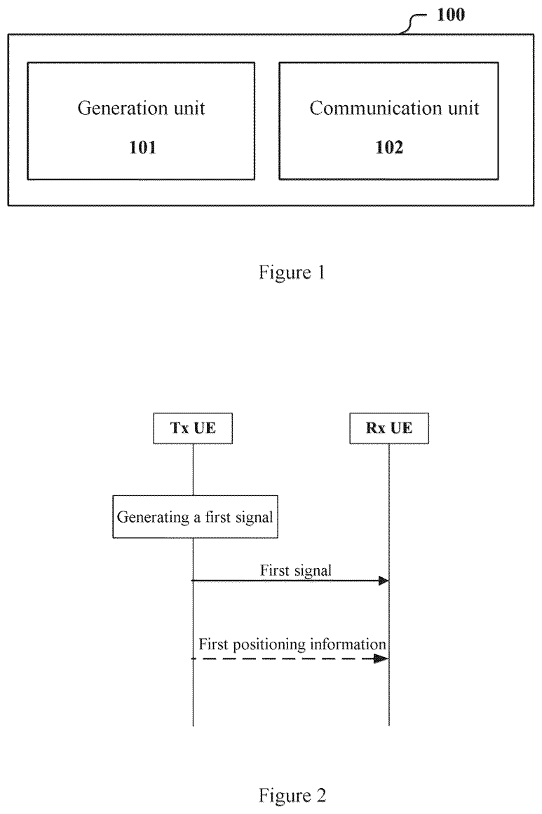

A relevant information flow between communication devices is shown in FIG. 2, in which, the first communication device is shown as a transmitting UE (Tx UE), and the second communication device is shown as a receiving UE (Rx UE). Tx UE generates the first signal based on a base station coverage state of itself and/or whether Tx UE has performed network side positioning, and transmits the first signal to Rx UE. In a case of the first signal indicating that Tx UE is within the coverage range of the base station and/or Tx UE has performed network side positioning, Tx UE further transmits first positioning information acquired through the network side positioning to the Rx UE. The dashed line in the FIG. 2 represents that the transmission of the first positioning information is optional. For example, in a case that Tx UE is not within the coverage range of the base station and/or Tx UE has not performed network side positioning, the transmission is not performed.

Based on the reception of the first signal, Rx UE may predict the nature of information to be received in the associated subframe. For example, in a case of the first signal indicating that Tx UE is within the coverage range of the base station and/or Tx UE has performed network side positioning, Rx UE may predict that the first positioning information, such as an absolute position of Tx UE, acquired by Tx UE through the network side positioning is to be received in the associated subframe. In this way, Rx UE may determine a degree of effort to decode a received data packet based on the nature of the information to be received in the associated subframe and/or its own requirements. For example, in a case that Rx UE determines that the first positioning information is to be received, it decodes the received data packet with a higher degree of effort; otherwise, it decodes the received data packet with a lower degree of effort.

The first signal may be notified in an explicit manner. For example, the communication unit 102 transmits the first signal through a first signaling. The first signaling may be a physical layer control signaling or a high-layer signaling. Specifically, the first signaling may be one of: a Sidelink Control Indicator (SCI), a Radio Resource Control (RRC) signaling, and MAC CE.

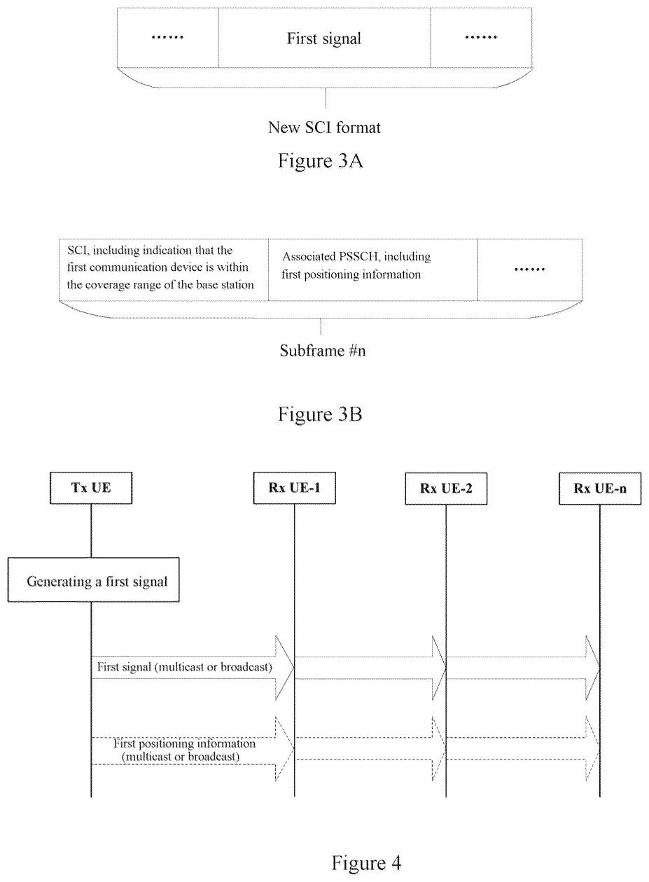

For example, in a scenario where Tx UE moves at a high speed, the base station coverage state of the Tx UE may vary frequently and dynamically, that is, the first signal is updated frequently. Thus, the first signal may be transmitted through the SCI. The SCI may be a first-level SCI or a second-level SCI, and correspond to a new SCI format. FIG. 3A shows an example of the new SCI format. A bit field in the new SCI format is set to be the first signal, to indicate the base station coverage state of Tx UE and/or whether Tx UE has performed network side positioning. This bit field includes at least one bit. In a case that the bit field includes one bit, for example, a value 1 of this bit may be used to indicate that Tx UE is within the coverage range of the base station and/or Tx UE has performed network side positioning, and a value 0 of this bit may be used to indicate that Tx UE is not within the coverage range of the base station and/or Tx UE has not performed network side positioning. It should be understood that above description is illustrative rather than restrictive.

Similarly, in a case that the first signaling is in another signaling form, the first signal may also be a bit field in the signaling, and the bit field includes at least one bit, which is not described redundantly herein.

In addition, the first signal may also be notified in an implicit manner. For example, the first signal may be a synchronization signal or a channel reference signal. The first signal indicates that the first communication device is within the coverage range of the base station and/or the first communication device has performed network side positioning in a case that the first signal meets one or more of: the first signal occupying specific time resources; the first signal occupying specific frequency resources; and the first signal adopting a specific sequence.

In other words, the time domain resources and/or the frequency domain resources or the sequence occupied by a sidelink synchronization signal block (S-SSB) or a sidelink channel reference signal may be used to indicate the base station coverage state of the first communication device and/or whether the first communication device has performed network side positioning. For example, a first resource subset may be set, and the S-SSB or the channel reference signal occupying resources within the first resource subset indicates that the first communication device is within the coverage range of the base station and/or the first communication device has performed network side positioning. The resources here may be one or more of the time domain resources, the frequency domain resources and the sequence. On the contrary, an S-SSB or a channel reference signal that does not occupy the resources within the first resource subset indicates that the first communication device is not within the coverage range of the base station and/or the first communication device has not performed network side positioning.

In addition, the first positioning information shown in FIG. 2 may be transmitted through a Physical Sidelink Shared Channel (PSSCH). For example, when the first signal is transmitted through the SCI, the first positioning information may be transmitted through the PSSCH associated with the SCI. The first positioning information may be used for positioning calculation by the Rx UE, which is to be described in detail hereinafter. FIG. 3B shows an example of a subframe including first positioning information, in which the subframe includes an SCI and a PSSCH associated with the SCI, and the SCI includes an indicator that the first communication device is within the coverage range of the base station and/or the first communication device has performed network side positioning. For example, the SCI includes the first signal with the value 1 described above, and the associated PSSCH includes the first positioning information.

In addition, the communication unit 102 may be configured to transmit the first signal and/or the first positioning information via multicast or broadcast, and a schematic diagram of a relevant information flow is shown in FIG. 4. In FIG. 4, Tx UE transmits the first signal to Rx UE-1 to Rx UE-n via multicast or broadcast. Optionally, in a case that the first signal indicates that Tx UE is within the coverage range of the base station and/or Tx UE has performed network side positioning, Tx UE transmits the first positioning information to Rx UE-1 to Rx UE-n via multicast or broadcast.

It should be noted that unicast is generally taken as an example in the following description, but the description is also applicable to multicast or broadcast situations.

As described above, the first positioning information is used by the second communication device to perform positioning calculation. In addition, the first communication device and the second communication device may further transmit positioning reference signals to each other, for example, to determine relative positions with respect to each other.

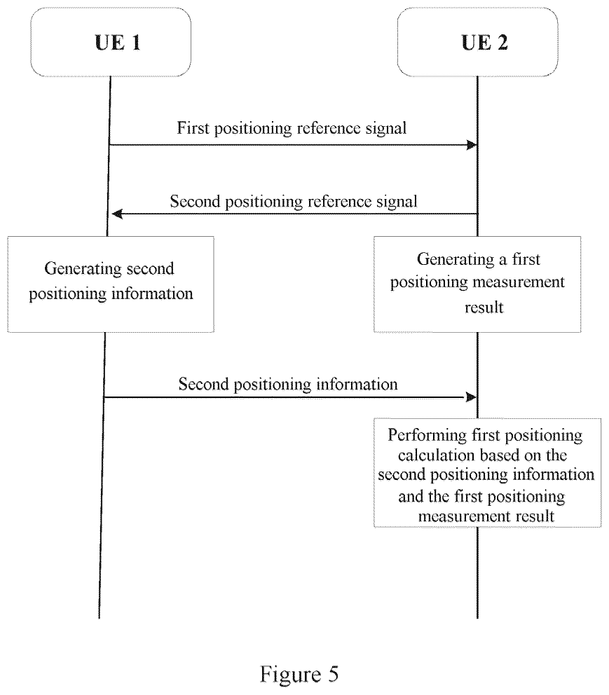

Specifically, the communication unit 102 may be further configured to transmit a first positioning reference signal for positioning measurement to the second communication device, where the second communication device generates a first positioning measurement result based on the first positioning reference signal. The communication unit 102 is further configured to receive, from the second communication device, a second positioning reference signal for positioning measurement, and the generation unit 101 generates second positioning information based on the second positioning reference signal. A relevant information flow is shown in FIG. 5, for example, in which the first communication device is shown as UE1 and the second communication device is shown as UE2.

For example, UE1 generates a time difference ΔT₁=t₁^{Rx}−t₁^{Tx} between receiving the second positioning reference signal and transmitting the first positioning reference signal as the second positioning information. UE2 generates a time difference ΔT₂=t₂^{Rx}−t₂^{Tx} between receiving the first positioning reference signal and transmitting the second positioning reference signal as the first positioning measurement result.

As shown in FIG. 5, the communication unit 102 may further be configured to transmit the second positioning information to the second communication device. The second communication device performs first positioning calculation based on the first positioning measurement result and the second positioning information. For example, in the example shown in FIG. 5, upon receiving the second positioning information, UE2 calculates a signal round trip time (RTT) RTT=ΔT₁+ΔT₂ based on the second positioning information ΔT₁ and the first positioning measurement result ΔT₂, and calculates a distance between UE2 and UE1 based on the RTT according to the electromagnetic signal propagation formula d=c·RTT/2, where c represents a speed of light 3×10⁸ m/s. In other words, UE2 obtains a relative position relationship between UE2 and UE1 through the first positioning calculation. This relative position relationship may be used for further positioning calculation subsequently. Specific examples will be given in the second embodiment.

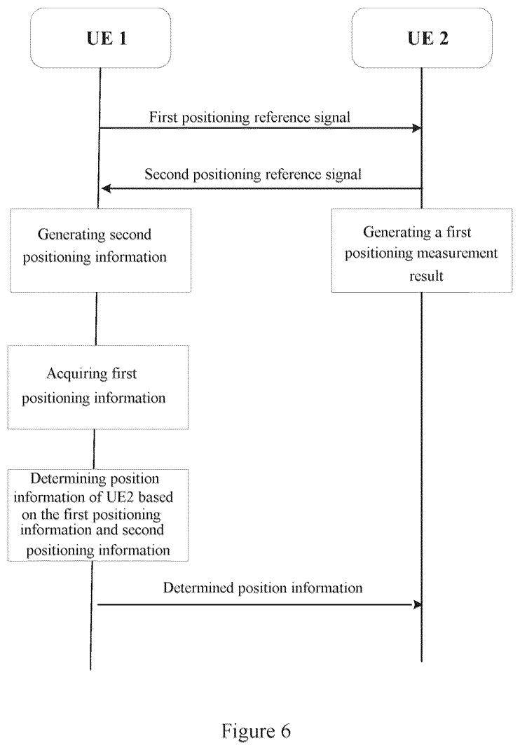

In another example, in a case of the first signal indicating that the first communication device is within the coverage range of the base station and/or the first communication device has performed network side positioning, the generation unit 101 is further configured to acquire first positioning information based on the network side positioning, and determine position information of the second communication device based on the first positioning information and the second positioning information. The communication unit 102 transmits the determined position information to the second communication device. A relevant information flow is shown in FIG. 6, for example. Similarly, the first communication device is shown as UE1, and the second communication device is shown as UE2.

In addition to generating the second positioning information ΔT₁=t₁^{Rx}−t₁^{Tx} as described above, UE1 further acquires the first positioning information such as an absolute position Pos₁ of UE1 through communication with the base station side and measurement. It should be noted that the acquisition of the first positioning information and the second positioning information shown in FIG. 6 does not represent a sequence, and is only illustrative. UE1 may estimate the distance d between UE1 and UE2 based on the second positioning information, and calculate position information such as a position range of UE2 based on the distance d and Pos₁. Alternatively, UE1 may acquire the first positioning measurement result from UE2, and calculate the distance d between UE2 and UE1 based on the second positioning information and the first positioning measurement result as described above, and further calculate the position range of UE2 based on the distance d and Pos₁.

In addition, FIG. 5 and FIG. 6 can also be combined, that is, UE1 transmits both the second positioning information and the determined position information to UE2, which is not limited.

In summary, the electronic apparatus 100 according to the embodiment indicates, through the first signal to another communication device in the sidelink communication, whether a present communication device is within the coverage range of the base station and/or whether the present communication device has performed network side positioning, so that another communication device can perform positioning calculation based on the first signal, thereby improving accuracy, efficiency and flexibility of the positioning.

### Second Embodiment

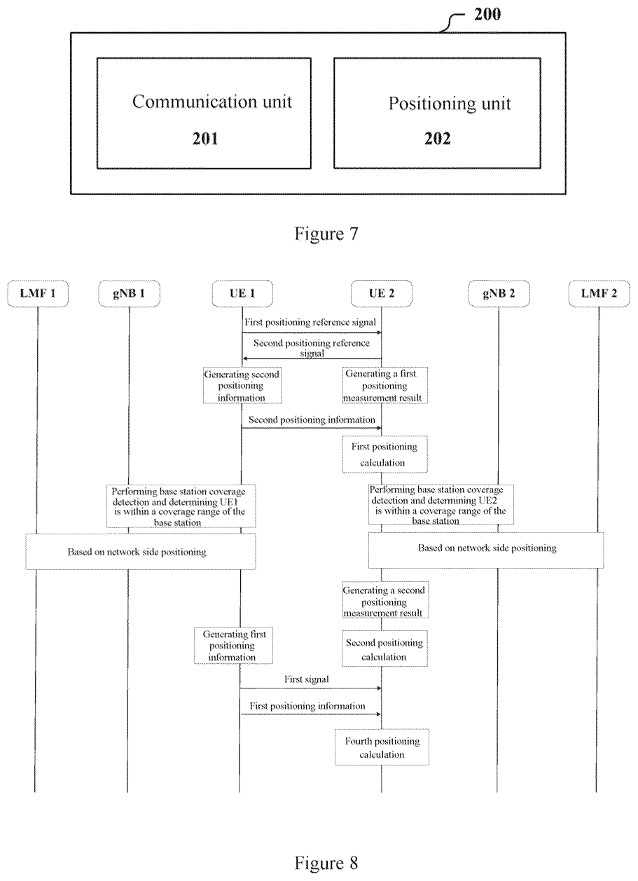

FIG. 7 shows a block diagram of functional modules of an electronic apparatus 200 according to an embodiment of the present disclosure. As shown in FIG. 7, the electronic apparatus 200 includes: a communication unit 201 and a positioning unit 202. The communication unit 201 is configured to receive, from a first communication device, a first signal which is used to indicate whether the first communication device is within a coverage range of a base station and/or whether the first communication device has performed network side positioning. The positioning unit 202 is configured to perform positioning calculation of a second communication device using the first signal.

The communication unit 201 and the positioning unit 202 may be implemented by one or more processing circuitries, and the processing circuitry, for example, may be implemented as a chip or a processor. Moreover, it should be understood that various functional units in the electronic apparatus shown in FIG. 7 are only logical modules divided based on the specific function thereof, and are not intended to limit a specific implementation.

The electronic apparatus 200 may be, for example, provided on a second communication device side or communicatively connected to the second communication device. The first communication device and the second communication device may be UE, for example. Exemplarily, in a vehicle-to-everything (V2X) communication scenario, the first communication device and the second communication device may be user equipment in V2X, and may be provided on a vehicle side, for example.

Here, it should also be noted that the electronic apparatus 200 may be implemented in a chip level or a device level. For example, the electronic apparatus 200 may operate as a communication device (such as UE) itself, and may further include an external device such as a memory, or a transceiver (not shown in FIG. 7). The memory may be used to store programs and related data information for the communication device to implement various functions. The transceiver may include one or more communication interfaces to support communication with different devices (for example, another communication device, a base station or the like), and the implementation of the transceiver is not limited herein.

The specific configuration and function of the first signal are described in detail in the first embodiment. The relevant content is also applicable to this embodiment, and thus is appropriately omitted below.

Correspondingly, the communication unit 201 may receive the first signal through a first signaling. The first signaling is a physical layer control signaling or a high-layer signaling. For example, the first signaling is one of: an SCI, a RRC signaling, and MAC CE. The first signal may be a bit field in the first signaling, and the bit field includes at least one bit.

In addition, the first signal may be notified in an implicit manner. For example, the first signal may be a synchronization signal or a channel reference signal. The positioning unit 202 is configured to determine that the first communication device is within the coverage range of the base station and/or the first communication device has performed network side positioning in a case of determining that the first signal meets one or more of: the first signal occupying specific time resources; the first signal occupying specific frequency resources; and the first signal adopting a specific sequence.

For example, the time domain resources and/or the frequency domain resources or the sequence occupied by a sidelink synchronization signal block (S-SSB) or a sidelink channel reference signal may be used to indicate a state of the first signal. For example, a first resource subset may be set, and the second communication device determines that the first communication device is within the coverage range of the base station and/or the first communication device has performed network side positioning when receiving the S-SSB or the channel reference signal occupying resources within the first resource subset. The resources here may be one or more of the time domain resources, the frequency domain resources, and the sequence. On the contrary, the second communication device determines that the first communication device is not within the coverage range of the base station and/or the first communication device has not performed network side positioning when receiving an S-SSB or a channel reference signal that does not occupy the resources within the first resource subset.

The communication unit 201 is further configured to, in a case of determining that the first communication device is within the coverage range of the base station and/or the first communication device has performed network side positioning based on the first signal, receive first positioning information transmitted by the first communication device acquired based on the network side positioning in a subframe associated with the first signal. The first positioning information is, for example, an absolute position of the first communication device. Specifically, the first positioning information is, for example, latitude and longitude coordinates of the first communication device. In another example, the first positioning information is a relative position of the first communication device. Specifically, the first positioning information is, for example, a relative position of the first communication device with respect to a reference point. For example, a position of the base station may serve as the reference point. For example, the first positioning information may be transmitted by the first communication device through the PSSCH.

As described above, based on the reception of the first signal, the second communication device may predict the nature of information to be received in the associated subframe. For example, in a case of the first signal indicating that the first communication device is within the coverage range of the base station and/or the first communication device has performed network side positioning, the second communication device may predict that the first positioning information, such as the absolute position of the first communication device, acquired by the first communication device through the network side positioning is to be received in the associated subframe. In this way, the second communication device may determine a degree of effort to decode a received data packet based on the nature of the information to be received in the associated subframe. For example, in a case that the second communication device desires to perform fine positioning and determines, through the first signal, that the second communication device would receive the first positioning information, the second communication device receives the PSSCH on the associated subframe and decodes the corresponding data. On the contrary, in a case that the second communication device determines, through the first signal, that the second communication device subsequently fails to receive the first positioning signal, the second communication device may give up receiving the PSSCH on the associated subframe.

In addition, as described in the first embodiment, the first signal and/or the first positioning information may be transmitted by the first communication device via multicast or broadcast. At this time, the second communication device may be one of communication devices receiving the first signal and/or the first positioning information. Although unicast is taken as an example in the following description, the description is also applicable to multicast or broadcast situation.

As described above, the first communication device and the second communication device may transmit positioning reference signals to each other, for example, to determine relative positions with respect to each other. Correspondingly, the communication unit 201 is configured to receive, from the first communication device, a first positioning reference signal for positioning measurement, and the positioning unit 202 is configured to generate a first positioning measurement result based on the first positioning reference signal. The communication unit 201 is further configured to transmit a second positioning reference signal for positioning measurement to the first communication device, where the first communication device generates second positioning information based on the second positioning reference signal.

In an example, the communication unit 201 is configured to receive the second positioning information from the first communication device, and the positioning unit 202 performs first positioning calculation of the second communication device based on the first positioning measurement result and the second positioning information. A relevant information flow may be referred to, for example, FIG. 5.

For example, the positioning unit 202 generates a time difference ΔT₂=t₂^{Rx}−t₂^{Tx} between receiving the first positioning reference signal and transmitting the second positioning reference signal as the first positioning measurement result. The first communication device generates a time difference ΔT₁=t₁^{Rx}−t₁^{Tx} between receiving the second positioning reference signal and transmitting the first positioning reference signal as the second positioning information. The first positioning calculation includes: calculating a signal round trip time (RTT) according to RTT=ΔT₁+ΔT₂ based on the second positioning information ΔT₁ and the first positioning measurement result ΔT₂, and calculating a distance between the first communication device and the second communication device based on the RTT according to the electromagnetic signal propagation formula d=c·RTT/2, where c represents the speed of light 3×10⁸ m/s.

In another example, the first communication device is within the coverage range of the base station and/or the first communication device has performed network side positioning, acquires the first positioning information based on the network side positioning, and determines position information of the second communication device based on the first positioning information and the second positioning information. The communication unit 201 receives, from the first communication device, the determined position information of the second communication device. A relevant information flow may be referred to, for example, FIG. 6. Here, the first communication device may determine the distance d between the first communication device and the second communication device based on the second positioning information, and calculate the position range of the second communication device based on the distance and absolute position information Pos₁ of the first communication device acquired through the network side positioning. It should be noted that in order to improve accuracy, the communication unit 201 may further provide the first positioning measurement result to the first communication device, so that the first communication device determines the distance d based on the first positioning measurement result and the second positioning information as described above.

In a case that the communication unit 201 receives the second positioning information from the first communication device, the positioning unit 202 may perform further positioning calculation, which depends on base station coverage states of the first communication device and the second communication device and/or whether the first communication device and the second communication device have performed the network side positioning. In a case that the first communication device and the second communication device are in different base station coverage states, examples of positioning calculation of the second communication device and relevant information flows are described below with reference to FIGS. 8 to 11 respectively. The positioning calculation described herein may include part or all of the first positioning calculation, second positioning calculation, third positioning calculation and fourth positioning calculation described below.

First, a first example is described, in which both the first communication device and the second communication device are within the coverage range of the base station and/or have performed the network side positioning.

The positioning unit 202 determines whether the second communication device is within the coverage range of the base station. In a case of determining that the second communication device is within the coverage range of the base station, the positioning unit 202 performs the network side positioning to acquire a second positioning measurement result, and performs second positioning calculation of the second communication device based on the first positioning measurement result, the second positioning information and the second positioning measurement result.

Furthermore, the communication unit 201 is further configured to, in a case of determining that the first communication device is within the coverage range of the base station and/or the first communication device has performed network side positioning based on the first signal, receive, from the first communication device, first positioning information acquired by the first communication device based on the network side positioning.

The positioning unit 202 performs fourth positioning calculation of the second communication device based on the first positioning information, the first positioning measurement result, the second positioning information and the second positioning measurement result.

FIG. 8 shows a schematic diagram of a relevant information flow, in which the first communication device is shown as UE1 and the second communication device is shown as UE2. First, similar to the above description, UE1 and UE2 transmit positioning reference signals to each other, UE1 generates the second positioning information, UE2 generates the first positioning measurement result, and UE1 provides the second positioning information to UE2. UE2 performs first positioning calculation based on the first positioning measurement result and the second positioning information, for example, to obtain an estimated distance d between UE1 and UE2.

In addition, UE1 and UE2 respectively perform base station coverage detection, and determine that UE1 is within a coverage range of a base station gNB 1 and UE2 is within a coverage range of a base station gNB 2. UE1 and UE2 respectively perform network side positioning using respective location management functions (LMF).

In a case of determining that UE2 is within the coverage range of the base station, UE2 performs the network side positioning using LMF to generate a second positioning measurement result such as absolute position information Pos₂ of UE2. The positioning unit 202 of UE2 performs the second positioning calculation based on the first positioning measurement result, the second positioning information and the second positioning measurement result. For example, the positioning unit 202 of UE2 may calculate the estimated distance between UE1 and UE2 based on the first positioning measurement result and the second positioning information, and calculate an absolute positioning range of UE1 based on the absolute position information Pos₂ of UE2 and the estimated distance d.

UE1 generates first positioning information such as the absolute position information Pos₁ of UE1 based on the network side positioning, and generates a first signal indicating that UE1 is within the coverage range of the base station and/or has performed the network side positioning. UE1 transmits the first signal and first positioning information to UE2.

The positioning unit 202 of UE2 performs the fourth positioning calculation based on the first positioning information, the first positioning measurement result, the second positioning information and the second positioning measurement result. For example, the positioning unit 202 may calculate the estimated distance d between UE1 and UE2 based on the first positioning measurement result and the second positioning information, and calculate relative positioning of UE1 and UE2 based on the absolute position information Pos₁ of UE1, the absolute position information Pos₂ of UE2 and the estimated distance d.

It can be seen that UE2 may acquire positioning information with different accuracy or different aspects through the first positioning calculation, the second positioning calculation and the fourth positioning calculation, improving the efficiency, accuracy and flexibility of the positioning calculation.

The positioning unit 202 may perform the first positioning calculation and/or the second positioning calculation before receiving the first signal, so as to acquire preliminary positioning information in time, further improving the efficiency of positioning calculation.

Next, a second example is described, in which the first communication device is within the coverage range of the base station and/or has performed network side positioning, and the second communication device is not within the coverage range of the base station and/or has not performed network side positioning.

Similar to the first example, the communication unit 201 is configured to, in a case of determining that the first communication device is within the coverage range of the base station and/or the first communication device has performed network side positioning based on the first signal, receive, from the first communication device, the first positioning information acquired by the first communication device based on the network side positioning.

In this example, the positioning unit 202 performs third positioning calculation of the second communication device based on the first positioning information, the first positioning measurement result, and the second positioning information.

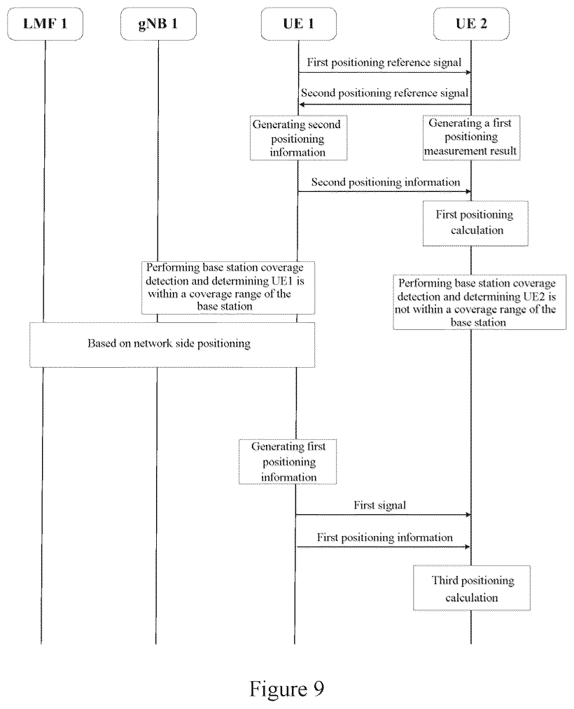

FIG. 9 shows a schematic diagram of a relevant information flow, in which the first communication device is shown as UE1 and the second communication device is shown as UE2. Parts related to the interaction of positioning reference signals and the first positioning calculation are the same as in FIG. 8 and are not repeated herein.

UE1 performs base station coverage detection, and determines that UE1 is within the coverage range of the base station gNB 1. UE2 performs base station coverage detection and determines that UE2 is not within the coverage range of any base station. UE1 performs network side positioning using LMF and generates the first positioning information such as absolute position information Pos₁ of UE1. In addition, UE1 further generates a first signal indicating that UE1 is within the coverage range of the base station and/or has performed network side positioning. UE1 transmits the first signal and first positioning information to UE2.

The positioning unit 202 of UE2 performs third positioning calculation based on the first positioning information, the first positioning measurement result and the second positioning information. For example, the positioning unit 202 of UE2 may calculate the estimated distance between UE1 and UE2 based on the first positioning measurement result and the second positioning information and calculate a position range of UE2 based on the absolute position information Pos₁ of UE1 and the estimated distance d.

Similarly, it can be seen from FIG. 9 that the positioning unit 202 may perform the first positioning calculation before receiving the first signal, so as to acquire preliminary positioning information in time, improving the efficiency of the positioning calculation.

A third example is described below, in which the first communication device is not within the coverage range of the base station and/or has not performed network side positioning, and the second communication device is within the coverage range of the base station and/or has performed network side positioning.

In this example, the positioning unit 202 is configured to, in a case of determining that the first communication device is not within the coverage range of the base station and/or the first communication device has not performed network side positioning based on the first signal, make use of a result of the first positioning calculation or a result of the second positioning calculation.

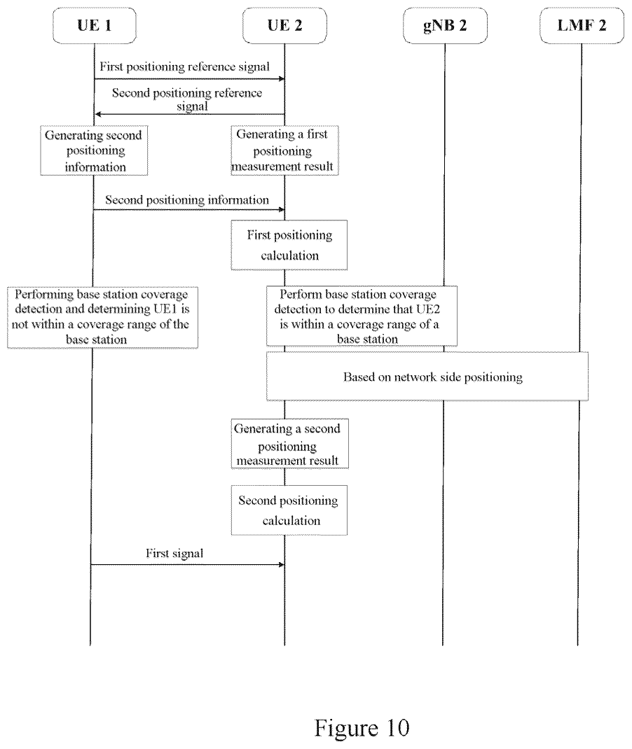

FIG. 10 shows a schematic diagram of a relevant information flow, in which the first communication device is shown as UE1 and the second communication device is shown as UE2. Parts related to the interaction of positioning reference signals and the first positioning calculation are the same as in FIG. 8 and are not repeated herein.

UE1 performs base station coverage detection, and determines that UE1 is not within the coverage range of any base station. UE2 performs base station coverage detection, and determines that UE2 is within the coverage range of gNB 2. UE2 performs network side positioning using LMF and generates a second positioning measurement result such as absolute position information Pos₂ of UE2.

The positioning unit 202 of UE2 performs second positioning calculation based on the second positioning information, the first positioning measurement result, and the second positioning measurement result. For example, the positioning unit 202 of UE2 may calculate the estimated distance d between UE1 and UE2 based on the first positioning measurement result and the second positioning information, and calculate an absolute positioning range of UE1 based on the absolute position information Pos₂ of UE2 and the estimated distance d.

In addition, UE1 further generates a first signal indicating that UE1 is not within the coverage range of the base station and/or has not performed network side positioning. UE1 transmits the first signal to UE2. Upon receiving the first signal, UE2 determines that UE2 would fail to acquire the first positioning information subsequently, and thus no longer performs other positioning calculation.

Similarly, it can be seen from FIG. 10 that the positioning unit 202 may perform the first positioning calculation and the second positioning calculation before receiving the first signal, so as to acquire preliminary positioning information in time, improving the efficiency of positioning calculation.

A fourth example is described below, in which the first communication device is not within the coverage range of the base station and/or the first communication device has not performed network side positioning, and the second communication device is not within the coverage range of the base station and/or has not performed network side positioning.

In this example, the positioning unit 202 is configured to, in a case of determining that the first communication device is not within the coverage range of the base station and/or the first communication device has not performed network side positioning based on the first signal, make use of the result of the first positioning calculation.

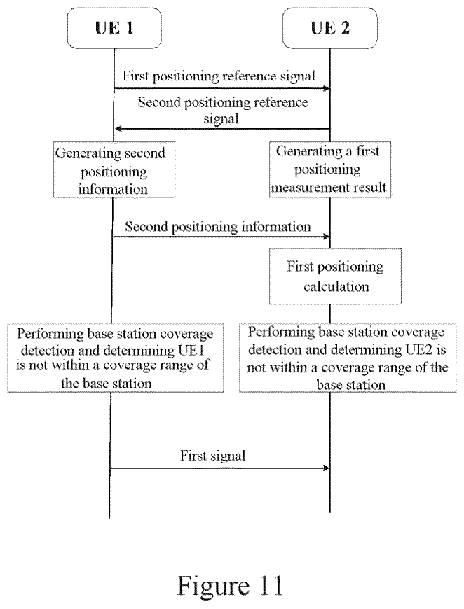

FIG. 11 shows a schematic diagram of a relevant information flow, in which the first communication device is shown as UE1 and the second communication device is shown as UE2. Parts related to the interaction of positioning reference signals and the first positioning calculation are the same as in FIG. 8 and are not repeated herein.

UE1 performs base station coverage detection, and determines that UE1 is not within the coverage range of any base station. UE2 performs base station coverage detection, and also determines that UE2 is not within the coverage range of any base station.

UE1 generates a first signal indicating that UE1 is not within the coverage range of the base station and/or has not performed network side positioning. UE1 transmits the first signal to UE2. Upon receiving the first signal, UE2 determines that UE2 would fail to acquire the first positioning information subsequently, and thus no longer performs other positioning calculation.

Similarly, it can be seen from FIG. 11 that the positioning unit 202 may perform the first positioning calculation before receiving the first signal, so as to acquire preliminary positioning information in time, improving the efficiency of the positioning calculation.

In summary, the electronic apparatus 200 according to the embodiment determines, through the first signal, whether another communication device in the sidelink communication is within the coverage range of the base station and/or whether the other communication device has performed network side positioning, so as to perform positioning calculation based on the first signal, thereby improving accuracy, efficiency and flexibility of the positioning.

As an example of a scenario, the electronic apparatus 100 and the electronic apparatus 200 according to the embodiments of the present disclosure may be applied to a Proximity Service (ProSe). The first communication device and the second communication device are user equipment in the ProSe. The proximity service includes, for example, Device to Device (D2D) communication, Vehicle to X (V2X, X represents a vehicle, a network infrastructure, or a pedestrian, or the like), Machine to Machine (M2M) network, and Internet of Things (IoT).

Taking the V2X scenario as an example, the first communication device and the second communication device may be user equipment in V2X. Where, determining whether the first communication device and the second communication device are within the coverage range of the base station may include determining whether the first communication device and the second communication device are within the coverage range of the gNB or within a coverage range of a Roadside Unit (RSU) which serves as the network infrastructure.

It should be understood that the above descriptions are only examples of scenarios and are not limiting. The embodiments of the present disclosure may be applied to any situation where sidelink positioning is used.

### Third Embodiment

In the above description of embodiments of the electronic apparatuses for wireless communications, it is apparent that some processing and methods are further disclosed. In the following, a summary of the methods are described without repeating details that are described above. However, it should be noted that although the methods are disclosed when describing the electronic apparatuses for wireless communications, the methods are unnecessary to adopt those components or to be performed by those components described above. For example, implementations of the electronic apparatuses for wireless communications may be partially or completely implemented by hardware and/or firmware. Methods for wireless communications to be discussed blow may be completely implemented by computer executable programs, although these methods may be implemented by the hardware and/or firmware for implementing the electronic apparatuses for wireless communications.

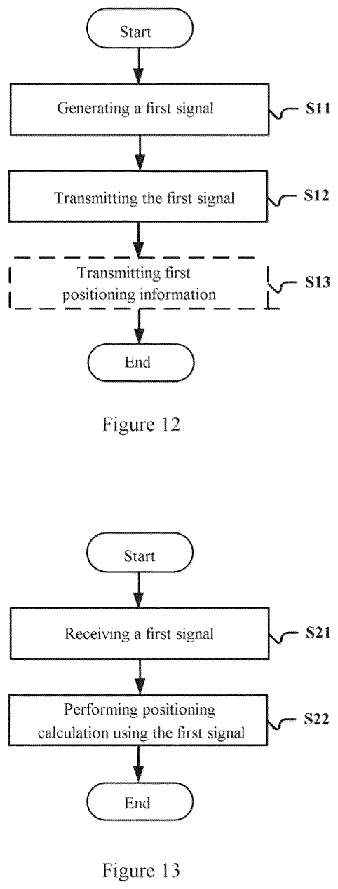

FIG. 12 shows a flow chart of a method for wireless communications according to an embodiment of the present disclosure. The method includes: generating a first signal (S11), where the first signal is used to indicate whether a first communication device is within a coverage range of a base station and/or whether the first communication device has performed network side positioning; and transmitting the first signal to one or more second communication devices (S12), where the first signal is used by the second communication device for positioning calculation. The method is performed, for example, on a first communication device side.

As shown in the dashed line block in FIG. 12, in a case that the first signal indicates that the first communication device is within the coverage range of the base station and/or the first communication device has performed network side positioning, the above method may further include the following step S13: transmitting first positioning information acquired by the first communication device based on the network side positioning in a subframe associated with the first signal. For example, the first positioning information may be transmitted through a PSSCH.

For example, the first signal may be transmitted through a first signaling. The first signaling is a physical layer control signaling or a high-layer signaling. The first signaling may be one of: an SCI, an RRC signaling, and MAC CE. The first signal is, for example, a bit field in the first signaling. The bit field includes at least one bit.

In addition, the first signal may be a synchronization signal or a channel reference signal. The first signal indicates that the first communication device is within the coverage range of the base station and/or the first communication device has performed network side positioning in a case that the first signal meets one or more of: the first signal occupying specific time resources; the first signal occupying specific frequency resources; and the first signal adopting a specific sequence.

The first signal and/or the first positioning information may be transmitted via multicast or broadcast.

In addition, although not shown in FIG. 12, the above method may further include: transmitting a first positioning reference signal for positioning measurement to the second communication device, where the second communication device generates a first positioning measurement result based on the first positioning reference signal; and receiving, from the second communication device, a second positioning reference signal for positioning measurement, and generating second positioning information based on the second positioning reference signal.

As an example, the above method may further include transmitting the second positioning information to the second communication device.

As another example, in a case of the first signal indicating that the first communication device is within the coverage range of the base station and/or the first communication device has performed network side positioning, the above method may include: acquiring the first positioning information based on the network side positioning, determining position information of the second communication device based on the first positioning information and the second positioning information, and transmitting the determined position information to the second communication device.

For example, the first communication device and the second communication device may be user equipment in Vehicle to everything.

The above method corresponds to the electronic apparatus 100 in the first embodiment. For specific details, reference may be made to the first embodiment and will not be repeated herein.

FIG. 13 shows a flow chart of a method for wireless communications according to another embodiment of the present disclosure. The method includes: receiving a first signal from a first communication device (S21), where the first signal is used to indicate whether the first communication device is within a coverage range of a base station and/or whether the first communication device has performed network side positioning; and perform positioning calculation of the second communication device using the first signal (S22). The method may be performed, for example, on a second communication device side.

In addition, in a case of determining that the first communication device is within the coverage range of the base station and/or the first communication device has performed network side positioning based on the first signal, the step S21 further includes acquiring first positioning information transmitted by the first communication device acquired based on the network side positioning in a subframe associated with the first signal. For example, the first positioning information may be transmitted by the first communication device through a PSSCH.

For example, the first signal may be received through a first signaling, which is a physical layer control signaling or a high-layer signaling. The first signaling may be one of: an SCI, an RRC signaling, and MAC CE. The first signal is, for example, a bit field in the first signaling. The bit field includes at least one bit.

In addition, the first signal may be a synchronization signal or a channel reference signal. It is determined that the first communication device is within the coverage range of the base station and/or the first communication device has performed network side positioning when the first signal meets one or more of: the first signal occupying specific time resources; the first signal occupying specific frequency resources; and the first signal adopting a specific sequence.

The first signal and/or the first positioning information may be transmitted by the first communication device via multicast or broadcast.

In addition, although not shown in FIG. 13, the above method may further include: receiving a first positioning reference signal for positioning measurement from the first communication device, and generating a first positioning measurement result based on the first positioning reference signal; transmitting a second positioning reference signal for positioning measurement to the first communication device, where the first communication device generates second positioning information based on the second positioning reference signal.

In an example, the above method further includes: receiving the second positioning information from the first communication device, and performing first positioning calculation of the second communication device based on the first positioning measurement result and the second positioning information.

In another example, the above method further includes: receiving, from the first communication device, position information of the second communication device determined by the first communication device, where the first communication device is within the coverage range of the base station and/or the first communication device has performed network side positioning, acquires first positioning information based on network side positioning, and determines the position information of the second communication device based on the first positioning information and the second positioning information.

In addition, the performed positioning operation may further include determining whether the second communication device is within the coverage range of the base station. In a case of determining that the second communication device is within the coverage range of the base station, the second communication device performs network side positioning to acquire a second positioning measurement result, and performs second positioning calculation of the second communication device based on the first positioning measurement result, the second positioning information and the second positioning measurement result.

It should be noted that the first positioning calculation and/or the second positioning calculation may be performed before receiving the first signal.

As described above, in a case of determining that the first communication device is within the coverage range of the base station and/or the first communication device has performed network side positioning based on the first signal, the step S21 further includes receiving the first positioning information from the first communication device. In this case, if the second communication device is not within the coverage range of the base station, third positioning calculation of the second communication device is performed based on the first positioning information, the first positioning measurement result and the second positioning information; and if the second communication device is within the coverage range of the base station, fourth positioning calculation of the second communication device is performed based on the first positioning information, the first positioning measurement result, the second positioning information and the second positioning measurement result.

In a case of determining that the first communication device is not within the coverage range of the base station and/or the first communication device has not performed network side positioning based on the first signal, the result of the first positioning calculation or the result of the second positioning calculation may be made use of.

Similarly, the first communication device and the second communication device may be user equipment in the Vehicle to everything.

The above method corresponds to the electronic apparatus 200 in the second embodiment. For specific details, reference may be made to the second embodiment and will not be repeated herein.

It should be noted that the above various methods may be used in combination or separately.

The electronic apparatus 100 and the electronic apparatus 200 may be implemented as various user equipments. The user equipment may be implemented as a mobile terminal (such as a smartphone, a tablet personal computer (PC), a notebook PC, a portable game terminal, a portable/dongle mobile router, and a digital camera) or a vehicle-mounted terminal (such as a car navigation apparatus). The user equipment may also be implemented as a terminal (also referred to as a machine-type communication (MTC) terminal) that performs machine-to-machine (M2M) communication. Furthermore, the user equipment may be a wireless communication module (such as an integrated circuitry module including a single die) mounted on each of the terminals described above.

### [Application Example Regarding User Equipment]

### First Application Example

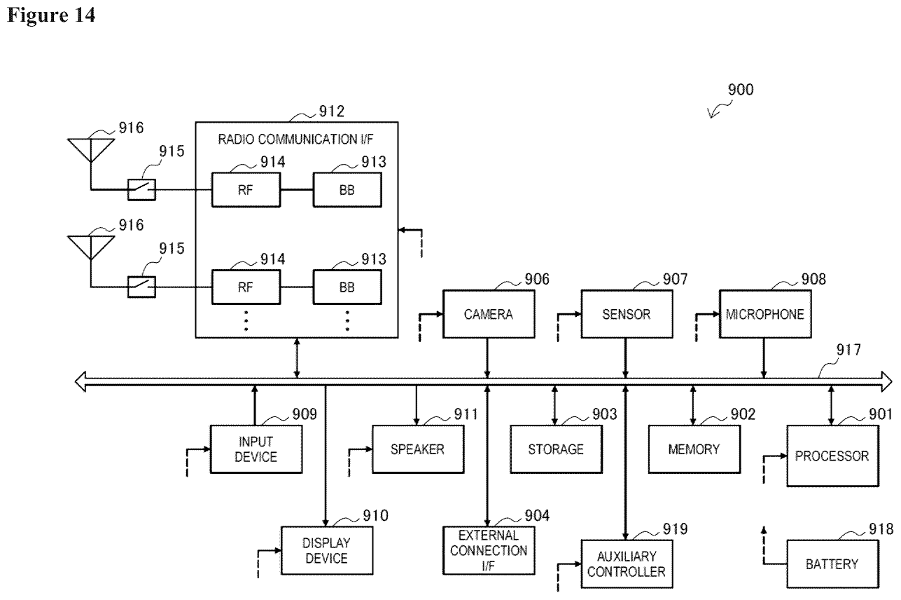

FIG. 14 is a block diagram showing an example of an exemplary configuration of a smartphone 900 to which the technology according to the present disclosure may be applied. The smartphone 900 includes a processor 901, a memory 902, a storage 903, an external connection interface 904, a camera 906, a sensor 907, a microphone 908, an input device 909, a display device 910, a speaker 911, a radio communication interface 912, one or more antenna switches 915, one or more antennas 916, a bus 917, a battery 918, and an auxiliary controller 919.

The processor 901 may be, for example, a CPU or a system on a chip (SoC), and controls functions of an application layer and another layer of the smartphone 900. The memory 902 includes a RAM and a ROM, and stores a program executed by the processor 901 and data. The storage 903 may include a storage medium such as a semiconductor memory and a hard disk. The external connection interface 904 is an interface for connecting an external device (such as a memory card and a universal serial bus (USB) device) to the smartphone 900.

The camera 906 includes an image sensor (such as a charge coupled device (CCD) and a complementary metal oxide semiconductor (CMOS)), and generates a captured image. The sensor 907 may include a group of sensors, such as a measurement sensor, a gyro sensor, a geomagnetism sensor, and an acceleration sensor. The microphone 908 converts sounds that are inputted to the smartphone 900 to audio signals. The input device 909 includes, for example, a touch sensor configured to detect touch onto a screen of the display device 910, a keypad, a keyboard, a button, or a switch, and receives an operation or information inputted from a user. The display device 910 includes a screen (such as a liquid crystal display (LCD) and an organic light-emitting diode (OLED) display), and displays an output image of the smartphone 900. The speaker 911 converts audio signals that are outputted from the smartphone 900 to sounds.

The radio communication interface 912 supports any cellular communication scheme (such as LTE and LTE-advanced), and performs a wireless communication. The radio communication interface 912 may include, for example, a BB processor 913 and an RF circuit 914. The BB processor 913 may perform, for example, encoding/decoding, modulating/demodulating, and multiplexing/de-multiplexing, and perform various types of signal processing for wireless communication. The RF circuit 914 may include, for example, a mixer, a filter and an amplifier, and transmits and receives wireless signals via the antenna 916. The radio communication interface 912 may be a chip module having the BB processor 913 and the RF circuit 914 integrated thereon. The radio communication interface 912 may include multiple BB processors 913 and multiple RF circuits 914, as shown in FIG. 14. Although FIG. 14 shows the example in which the radio communication interface 912 includes the multiple BB processors 913 and the multiple RF circuits 914, the radio communication interface 912 may also include a single BB processor 913 or a single RF circuit 914.

Furthermore, in addition to a cellular communication scheme, the radio communication interface 912 may support another type of wireless communication scheme such as a short-distance wireless communication scheme, a near field communication scheme, and a radio local area network (LAN) scheme. In this case, the radio communication interface 912 may include the BB processor 913 and the RF circuit 914 for each wireless communication scheme.

Each of the antenna switches 915 switches connection destinations of the antennas 916 among multiple circuits (such as circuits for different wireless communication schemes) included in the radio communication interface 912.

Each of the antennas 916 includes a single or multiple antenna elements (such as multiple antenna elements included in an MIMO antenna) and is used for the radio communication interface 912 to transmit and receive wireless signals. The smartphone 900 may include the multiple antennas 916, as shown in FIG. 14. Although FIG. 14 shows the example in which the smartphone 900 includes the multiple antennas 916, the smartphone 900 may also include a single antenna 916.

Furthermore, the smartphone 900 may include the antenna 916 for each wireless communication scheme. In this case, the antenna switches 915 may be omitted from the configuration of the smartphone 900.

The bus 917 connects the processor 901, the memory 902, the storage 903, the external connection interface 904, the camera 906, the sensor 907, the microphone 908, the input device 909, the display device 910, the speaker 911, the radio communication interface 912, and the auxiliary controller 919 to each other. The battery 918 supplies power to blocks of the smart phone 900 shown in FIG. 14 via feeder lines that are partially shown as dashed lines in FIG. 14. The auxiliary controller 919 operates, for example, in a sleep mode to achieve a minimum necessary function of the smart phone 900.

In the smartphone 900 shown in FIG. 14, the communication unit 102, the transceiver of the electronic apparatus 100 or the communication unit 201, the transceiver of the electronic apparatus 200 may be implemented by the radio communication interface 912. At least a part of functions may be implemented by the processor 901 or the auxiliary controller 919. For example, the processor 901 or the auxiliary controller 919 may perform the functions of the generation unit 101 and the communication unit 102 to implement the generation and transmission of the first signal, and the generation and transmission of the first positioning information and the second positioning information, and perform the functions of the communication unit 201 and the positioning unit 202 to implement the reception of the first signal, the reception of the first positioning information and the second positioning information, and various positioning calculation.

### Second Application Example

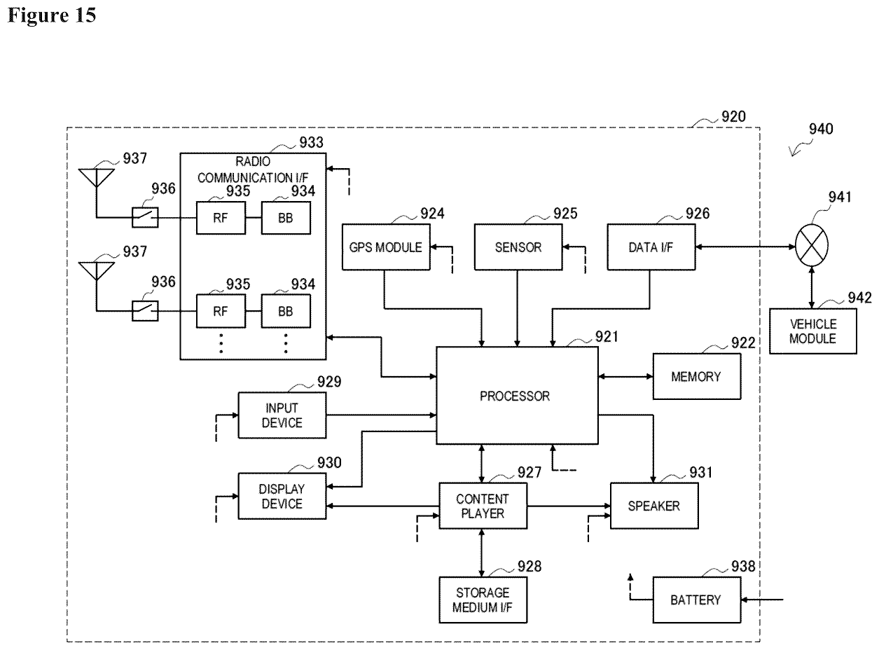

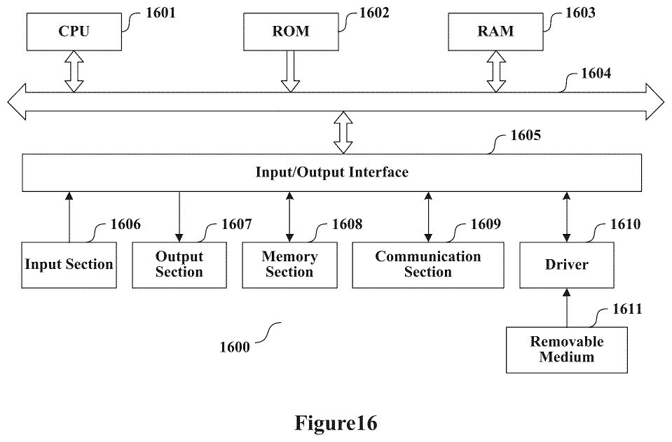

FIG. 15 is a block diagram showing an example of an exemplary configuration of a car navigation apparatus 920 to which the technology according to the present disclosure may be applied. The car navigation apparatus 920 includes a processor 921, a memory 922, a global positioning system (GPS) module 924, a sensor 925, a data interface 926, a content player 927, a storage medium interface 928, an input device 929, a display device 930, a speaker 931, a radio communication interface 933, one or more antenna switches 936, one or more antennas 937, and a battery 938.

The processor 921 may be, for example a CPU or a SoC, and controls a navigation function and additional function of the car navigation apparatus 920. The memory 922 includes RAM and ROM, and stores a program that is executed by the processor 921, and data.

The GPS module 924 determines a position (such as latitude, longitude and altitude) of the car navigation apparatus 920 by using GPS signals received from a GPS satellite. The sensor 925 may include a group of sensors such as a gyro sensor, a geomagnetic sensor and an air pressure sensor. The data interface 926 is connected to, for example, an in-vehicle network 941 via a terminal that is not shown, and acquires data (such as vehicle speed data) generated by the vehicle.

The content player 927 reproduces content stored in a storage medium (such as a CD and a DVD) that is inserted into the storage medium interface 928. The input device 929 includes, for example, a touch sensor configured to detect touch onto a screen of the display device 930, a button, or a switch, and receives an operation or information inputted from a user. The display device 930 includes a screen such as an LCD or OLED display, and displays an image of the navigation function or content that is reproduced. The speaker 931 outputs a sound for the navigation function or the content that is reproduced.

The radio communication interface 933 supports any cellular communication scheme (such as LTE and LTE-Advanced), and performs wireless communication. The radio communication interface 933 may typically include, for example, a BB processor 934 and an RF circuit 935. The BB processor 934 may perform, for example, encoding/decoding, modulating/demodulating and multiplexing/demultiplexing, and perform various types of signal processing for wireless communication. The RF circuit 935 may include, for example, a mixer, a filter and an amplifier, and transmits and receives wireless signals via the antenna 937. The radio communication interface 933 may also be a chip module having the BB processor 934 and the RF circuit 935 integrated thereon. The radio communication interface 933 may include multiple BB processors 934 and multiple RF circuits 935, as shown in FIG. 15. Although FIG. 15 shows the example in which the radio communication interface 933 includes the multiple BB processors 934 and the multiple RF circuits 935, the radio communication interface 933 may also include a single BB processor 934 and a single RF circuit 935.

Furthermore, in addition to a cellular communication scheme, the radio communication interface 933 may support another type of wireless communication scheme such as a short-distance wireless communication scheme, a near field communication scheme, and a wireless LAN scheme. In this case, the radio communication interface 933 may include the BB processor 934 and the RF circuit 935 for each wireless communication scheme.

Each of the antenna switches 936 switches connection destinations of the antennas 937 among multiple circuits (such as circuits for different wireless communication schemes) included in the radio communication interface 933.

Each of the antennas 937 includes a single or multiple antenna elements (such as multiple antenna elements included in an MIMO antenna), and is used by the radio communication interface 933 to transmit and receive wireless signals. As shown in FIG. 15, the car navigation apparatus 920 may include the multiple antennas 937. Although FIG. 15 shows the example in which the car navigation apparatus 920 includes the multiple antennas 937, the car navigation apparatus 920 may also include a single antenna 937.

Furthermore, the car navigation apparatus 920 may include the antenna 937 for each wireless communication scheme. In this case, the antenna switches 936 may be omitted from the configuration of the car navigation apparatus 920.

The battery 938 supplies power to the blocks of the car navigation apparatus 920 shown in FIG. 15 via feeder lines that are partially shown as dash lines in FIG. 15. The battery 938 accumulates power supplied from the vehicle.

In the car navigation apparatus 920 shown in FIG. 15, the communication unit 102 and the transceiver of the electronic apparatus 100 or the communication unit 201 and the transceiver of the electronic apparatus 200 may be implemented by the radio communication interface 933. At least part of the functions may also be implemented by the processor 921. For example, the processor 921 may perform the functions of the generation unit 101 and the communication unit 102 to implement the generation and transmission of the first signal, the generation and transmission of the first positioning information and the second positioning information, and perform the functions of the communication unit 201 and the positioning unit 202 to implement the reception of the first signal, the reception of the first positioning information and the second positioning information, and various positioning calculation.

The technology of the present disclosure may also be implemented as an in-vehicle system (or a vehicle) 940 including one or more blocks of the car navigation apparatus 920, the in-vehicle network 941 and a vehicle module 942. The vehicle module 942 generates vehicle data (such as a vehicle speed, an engine speed, and failure information), and outputs the generated data to the in-vehicle network 941.

The basic principle of the present disclosure has been described above in conjunction with particular embodiments. However, as can be appreciated by those ordinarily skilled in the art, all or any of the steps or components of the method and apparatus according to the disclosure can be implemented with hardware, firmware, software or a combination thereof in any computing device (including a processor, a storage medium, etc.) or a network of computing devices by those ordinarily skilled in the art in light of the disclosure of the disclosure and making use of their general circuit designing knowledge or general programming skills.

Moreover, the present disclosure further discloses a program product in which machine-readable instruction codes are stored. The aforementioned methods according to the embodiments can be implemented when the instruction codes are read and executed by a machine.

Accordingly, a memory medium for carrying the program product in which machine-readable instruction codes are stored is also covered in the present disclosure. The memory medium includes but is not limited to soft disc, optical disc, magnetic optical disc, memory card, memory stick and the like.

In the case where the present disclosure is realized with software or firmware, a program constituting the software is installed in a computer with a dedicated hardware structure (e.g. the general computer 1600 shown in FIG. 16) from a storage medium or network, wherein the computer is capable of implementing various functions when installed with various programs.

In FIG. 16, a central processing unit (CPU) 1601 executes various processing according to a program stored in a read-only memory (ROM) 1602 or a program loaded to a random access memory (RAM) 1603 from a memory section 1608. The data needed for the various processing of the CPU 1601 may be stored in the RAM 1603 as needed. The CPU 1601, the ROM 1602 and the RAM 1603 are linked with each other via a bus 1604. An input/output interface 1605 is also linked to the bus 1604.

The following components are linked to the input/output interface 1605: an input section 1606 (including keyboard, mouse and the like), an output section 1607 (including displays such as a cathode ray tube (CRT), a liquid crystal display (LCD), a loudspeaker and the like), a memory section 1608 (including hard disc and the like), and a communication section 1609 (including a network interface card such as a LAN card, modem and the like). The communication section 1609 performs communication processing via a network such as the Internet. A driver 1610 may also be linked to the input/output interface 1605, if needed. If needed, a removable medium 1611, for example, a magnetic disc, an optical disc, a magnetic optical disc, a semiconductor memory and the like, may be installed in the driver 1610, so that the computer program read therefrom is installed in the memory section 1608 as appropriate.

In the case where the foregoing series of processing is achieved through software, programs forming the software are installed from a network such as the Internet or a memory medium such as the removable medium 1611.

It should be appreciated by those skilled in the art that the memory medium is not limited to the removable medium 1611 shown in FIG. 16, which has program stored therein and is distributed separately from the apparatus so as to provide the programs to users. The removable medium 1611 may be, for example, a magnetic disc (including floppy disc (registered trademark)), a compact disc (including compact disc read-only memory (CD-ROM) and digital versatile disc (DVD), a magneto optical disc (including mini disc (MD) (registered trademark)), and a semiconductor memory. Alternatively, the memory medium may be the hard discs included in ROM 1602 and the memory section 1608 in which programs are stored, and can be distributed to users along with the device in which they are incorporated.

To be further noted, in the apparatus, method and system according to the present disclosure, the respective components or steps can be decomposed and/or recombined. These decompositions and/or re-combinations shall be regarded as equivalent solutions of the disclosure. Moreover, the above series of processing steps can naturally be performed temporally in the sequence as described above but will not be limited thereto, and some of the steps can be performed in parallel or independently from each other.

Finally, to be further noted, the term “include”, “comprise” or any variant thereof is intended to encompass nonexclusive inclusion so that a process, method, article or device including a series of elements includes not only those elements but also other elements which have been not listed definitely or an element(s) inherent to the process, method, article or device. Moreover, the expression “comprising a(n) . . . ” in which an element is defined will not preclude presence of an additional identical element(s) in a process, method, article or device comprising the defined element(s)” unless further defined.

Although the embodiments of the present disclosure have been described above in detail in connection with the drawings, it shall be appreciated that the embodiments as described above are merely illustrative rather than limitative of the present disclosure. Those skilled in the art can make various modifications and variations to the above embodiments without departing from the spirit and scope of the present disclosure. Therefore, the scope of the present disclosure is defined merely by the appended claims and their equivalents.

1. An electronic apparatus for wireless communications, comprising:
at least one processor; and
at least one memory including computer program code, where the at least one memory and the computer program code are configured, with the at least one processor, to cause the electronic apparatus to:
generate a first signal, which is used to indicate whether a first communication device is within a coverage range of a base station and/or whether the first communication device has performed network side positioning; and
transmit the first signal to one or more second communication devices, wherein, the first signal is used by the second communication device for positioning calculation.

2. The electronic apparatus according to claim 1, wherein the at least one memory and the computer program code are further configured, with the at least one processor, to cause the electronic apparatus to, in case of the first signal indicating that the first communication device is within the coverage range of the base station and/or the first communication device has performed network side positioning, transmit first positioning information acquired by the first communication device based on the network side positioning in a subframe associated with the first signal.

3. The electronic apparatus according to claim 2, wherein the at least one memory and the computer program code are configured, with the at least one processor, to cause the electronic apparatus to:
transmit the first signal and/or the first positioning information via multicast or broadcast; and/or
transmit the first positioning information through a physical sidelink shared channel.

4. (canceled)

5. The electronic apparatus according to claim 1, wherein the at least one memory and the computer program code are configured, with the at least one processor, to cause the electronic apparatus to transmit the first signal through a first signaling which is a physical layer control signaling or a high-layer signaling,
wherein the first signaling is one of a sidelink control indicator, a radio resource control signaling and MAC CE,
wherein the first signal is a bit field in the first signaling, and the bit field comprises at least one bit.

6.-7. (canceled)

8. The electronic apparatus according to claim 1, wherein the first signal is a synchronization signal or a channel reference signal, and the first signal indicates that the first communication device is within the coverage range of the base station and/or the first communication device has performed network side positioning in a case that the first signal meets one or more of:
the first signal occupying specific time resources;
the first signal occupying specific frequency resources; and
the first signal adopting a specific sequence.

9. The electronic apparatus according to claim 1, wherein the at least one memory and the computer program code are further configured, with the at least one processor, to cause the electronic apparatus to transmit a first positioning reference signal for positioning measurement to the second communication device, wherein the second communication device generates a first positioning measurement result based on the first positioning reference signal.

10. The electronic apparatus according to claim 1, wherein the at least one memory and the computer program code are further configured, with the at least one processor, to cause the electronic apparatus to:
receive, from the second communication device, a second positioning reference signal for positioning measurement, and generate second positioning information based on the second positioning reference signal; and
transmit the second positioning information to the second communication device.

11. (canceled)

12. The electronic apparatus according to claim 10, wherein, in a case of the first signal indicating that the first communication device is within the coverage range of the base station and/or the first communication device has performed network side positioning, the at least one memory and the computer program code are further configured, with the at least one processor, to cause the electronic apparatus to:
acquire first positioning information based on the network side positioning;
determine position information of the second communication device based on the first positioning information and the second positioning information; and
transmit the determined position information to the second communication device.

13. The electronic apparatus according to claim 1, wherein the first communication device and the second communication device are user equipment in Vehicle to everything.

14. An electronic apparatus for wireless communications, comprising:
at least one processor; and
at least one memory including computer program code, where the at least one memory and the computer program code are configured, with the at least one processor, to cause the electronic apparatus to:
receive, from a first communication device, a first signal which is used to indicate whether the first communication device is within a coverage range of a base station and/or whether the first communication device has performed network side positioning; and
perform positioning calculation of a second communication device using the first signal.

15. The electronic apparatus according to claim 14, wherein the at least one memory and the computer program code are further configured, with the at least one processor, to cause the electronic apparatus to, in a case of determining that the first communication device is within the coverage range of the base station and/or the first communication device has performed network side positioning based on the first signal, receive first positioning information transmitted by the first communication device acquired based on the network side positioning in a subframe associated with the first signal.

16.-20. (canceled)

21. The electronic apparatus according to claim 14, wherein the first signal is a synchronization signal or a channel reference signal, and the processing circuitry is configured to determine that the first communication device is within the coverage range of the base station and/or the first communication device has performed network side positioning in a case of determining that the first signal meets one or more of:
the first signal occupying specific time resources;
the first signal occupying specific frequency resources; and
the first signal adopting a specific sequence.

22. The electronic apparatus according to claim 14, wherein the at least one memory and the computer program code are further configured, with the at least one processor, to cause the electronic apparatus to receive a first positioning reference signal for positioning measurement from the first communication device, and generate a first positioning measurement result based on the first positioning reference signal.

23. The electronic apparatus according to claim 22, wherein the at least one memory and the computer program code are further configured, with the at least one processor, to cause the electronic apparatus to:
transmit a second positioning reference signal for positioning measurement to the first communication device, wherein the first communication device generates second positioning information based on the second positioning reference signal; and
receive the second positioning information from the first communication device, and perform first positioning calculation of the second communication device based on the first positioning measurement result and the second positioning information.

24. (canceled)

25. The electronic apparatus according to claim 23, wherein the at least one memory and the computer program code are further configured, with the at least one processor, to cause the electronic apparatus:
determine whether the second communication device is within the coverage range of the base station; and
perform network side positioning to acquire a second positioning measurement result, and perform second positioning calculation of the second communication device based on the first positioning measurement result, the second positioning information and the second positioning measurement result, in a case of determining that the second communication device is within the coverage range of the base station.

26. The electronic apparatus according to claim 25, wherein the at least one memory and the computer program code are configured, with the at least one processor, to cause the electronic apparatus to perform the first positioning calculation and/or the second positioning calculation before receiving the first signal.

27. The electronic apparatus according to claim 25, wherein the at least one memory and the computer program code are further configured, with the at least one processor, to cause the electronic apparatus to, in a case of determining that the first communication device is within the coverage range of the base station and/or the first communication device has performed network side positioning based on the first signal, receive, from the first communication device, first positioning information acquired by the first communication device based on the network side positioning;
perform third positioning calculation of the second communication device based on the first positioning information, the first positioning measurement result and the second positioning information, in a case that the second communication is not within the coverage range of the base station; and
perform fourth positioning calculation of the second communication device based on the first positioning information, the first positioning measurement result, the second positioning information and the second positioning measurement result, in a case that the second communication device is within the coverage range of the base station.

28. The electronic apparatus according to claim 25, wherein the at least one memory and the computer program code are further configured, with the at least one processor, to cause the electronic apparatus to, in a case of determining that the first communication device is not within the coverage range of the base station and/or the first communication device has not performed network side positioning based on the first signal, make use of a result of the first positioning calculation or a result of the second positioning calculation.

29. The electronic apparatus according to claim 23, wherein the at least one memory and the computer program code are further configured, with the at least one processor, to cause the electronic apparatus to receive, from the first communication device, position information of the second communication device determined by the first communication device, wherein
the first communication device is within the coverage range of the base station and/or the first communication device has performed network side positioning, acquires first positioning information based on the network side positioning and determines the position information of the second communication device based on the first positioning information and the second positioning information.

30. (canceled)

31. A method for wireless communications, comprising:
generating a first signal, which is used to indicate whether a first communication device is within a coverage range of a base station and/or whether the first communication device has performed network side positioning; and
transmitting the first signal to one or more second communication devices, wherein, the first signal is used by the second communication device for positioning calculation.

32.-33. (canceled)
